(19) United States
(12) Patent Application Publication
(10) Pub. No.: US 2016/0275873 A1
(43) Pub. Date: Sep. 22, 2016

(54) MODIFYING CONTENT FOR ELECTRONIC PAPER DISPLAY DEVICES

(71) Applicant: Microsoft Technology Licensing, LLC, Redmond, WA (US)

(72) Inventors: Stuart Taylor, Cambridge (GB); John Franciscus Marie Helmes, Steyl (NL); James Scott, Cambridge (GB); Nicholas Yen-Cherng Chen, Cambridge (GB); Stephen Edward Hodges, Cambridge (GB)

(21) Appl. No.: 14/664,599

(22) Filed: Mar. 20, 2015

(51) Int. Cl. G09G 3/34; G06F 3/0484

(52) U.S. Cl. CPC G09G 3/344; G06F 3/04842; G09G 2370/16; G09G 2300/0473; G09G 2360/08

(57) ABSTRACT

A display device is described which comprises an electronic paper display, a transmitter, a digital data and power bus and a processor. The transmitter is configured to transmit data identifying content currently displayed on the electronic paper display. The digital data and power bus is arranged to receive pixel data for modified content associated with the transmitted data and the processor is configured to drive the electronic paper display; however, the electronic paper display can only be updated to display modified content when the display device is receiving power via the digital data and power bus.

### BACKGROUND

Electronic paper (or e-paper) is commonly used for e-reader devices because it only requires power to change the image displayed and does not require continuous power to maintain the display in between. The electronic paper can therefore hold static images or text for long periods of time (e.g. from several minutes to several hours and even several days, months or years in some examples) without requiring significant power (e.g. without any power supply or with only minimal power consumption). There are a number of different technologies which are used to provide the display, including electrophoretic displays and electro-wetting displays. Many types of electronic paper displays are also referred to as ‘bi-stable’ displays because they use a mechanism in which a pixel can move between stable states (e.g. a black state and a white state) when powered but holds its state when power is removed.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

A display device is described which comprises an electronic paper display, a transmitter, a digital data and power bus and a processor. The transmitter is configured to transmit data identifying content currently displayed on the electronic paper display. The digital data and power bus is arranged to receive pixel data for modified content associated with the transmitted data and the processor is configured to drive the electronic paper display; however, the electronic paper display can only be updated to display modified content when the display device is receiving power via the digital data and power bus. In various examples, the transmitter is a proximity based wireless device.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows two schematic diagrams of example systems comprising a computing device and a display device which comprises an electronic paper display;

FIG. 2 is a schematic diagram showing the display device from the second example system in FIG. 1 in more detail;

FIG. 3 is a schematic diagram showing the printer device from the second example system in FIG. 1 in more detail;

FIG. 4 is a flow diagram showing an example method of operation of the computing device shown in FIG. 1;

FIG. 5 shows two examples of how content may be modified using the method of FIG. 4;

FIG. 6 shows two further examples of how content may be modified using the method of FIG. 4;

FIG. 7 shows a further example of how content may be modified using the method of FIG. 4;

FIG. 8 shows a further example of how content may be modified using the method of FIG. 4; and

FIG. 9 illustrates various components of an exemplary computing-based device which may implement the method of FIG. 4.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

E-reader devices often use a bi-stable display because they have much lower power consumption than backlit liquid crystal displays (LCDs) or LED displays, which require power to be able to display content. In contrast, a bi-stable display requires power to change state (i.e. change the image/text displayed) but does not require power to maintain a static display. However, despite the difference in display technologies used by e-reader devices, which typically employ bi-stable displays, and tablet computers, which typically employ LCDs or LED displays, the hardware architecture of e-readers and tablet computers is very similar. Both types of device contain a battery, a processor, a wired or wireless communications module, and user interaction hardware (e.g. to provide a touch-sensitive screen and one or more physical controls such as buttons).

Whilst bi-stable displays have a lower power consumption, unless the display device comprises a battery, a processor (and associated software stack), and touch/pen sensor or keyboard for user input, for example, to enable the displayed image to be changed, the interactivity of the display device is limited. However, inclusion of a suitable power supply and processor, among other components, results in a display device that is significantly larger (e.g. thicker and heavier) than an electronic paper display.

The embodiments described below are not limited to implementations that solve any or all of the disadvantages of known ways of enabling a user to interact with and modify content displayed on an electronic paper display.

Described herein is a method of modifying content which is to be displayed (i.e. rendered) on an electronic paper display in a display device. As described in more detail below, proximity based wireless networking techniques are used to read data from the display device which comprises the electronic paper display and the data that is read identifies the content which is currently being displayed on the electronic paper display. Modified content is then generated based on the identified content (e.g. either automatically or with user input) and then the method causes the modified content to be displayed on the same display device (i.e. on the same electronic paper display as the original, unmodified content). This method may be implemented on a handheld computing device, such as a smartphone, tablet computing device, handheld games console, wearable device (e.g. a wrist-worn or head-worn computer) or a wearable composite device (e.g. a computer comprising a head-worn display and a hand-mounted proximity sensor).

The term ‘electronic paper’ is used herein to refer to display technologies which reflect light (like paper) instead of emitting light like conventional LCD displays. As they are reflective, electronic paper displays do not require a significant amount of power to maintain an image on the display and so may be described as persistent displays. A multi-stable display is an example of an electronic paper display. In some display devices, an electronic paper display may be used together with light generation in order to enable a user to more easily read the display when ambient light levels are too low (e.g. when it is dark). In such examples, the light generation is used to illuminate the electronic paper display to improve its visibility rather than being part of the image display mechanism and the electronic paper does not require light to be emitted in order to function.

The term ‘multi-stable display’ is used herein to describe a display which comprises pixels that can move between two or more stable states (e.g. a black state and a white state and/or a series of grey or colored states). Bi-stable displays, which comprise pixels having two stable states, are therefore examples of multi-stable displays. A multi-stable display can be updated when powered, but holds a static image when not powered and as a result can display static images for long periods of time with minimal or no external power. Consequently, a multi-stable display may also be referred to as a ‘persistent display’ or ‘persistently stable’ display.

The electronic paper displays described herein are reflective bit-mapped/pixelated displays that provide display elements, such as pixels, to enable arbitrary content to be displayed.

In various examples, the display devices 106 described below may be described as ‘non-networked displays’ because whilst they can maintain an image without requiring significant power, they have no automatic means of updating their content other than via the method described herein.

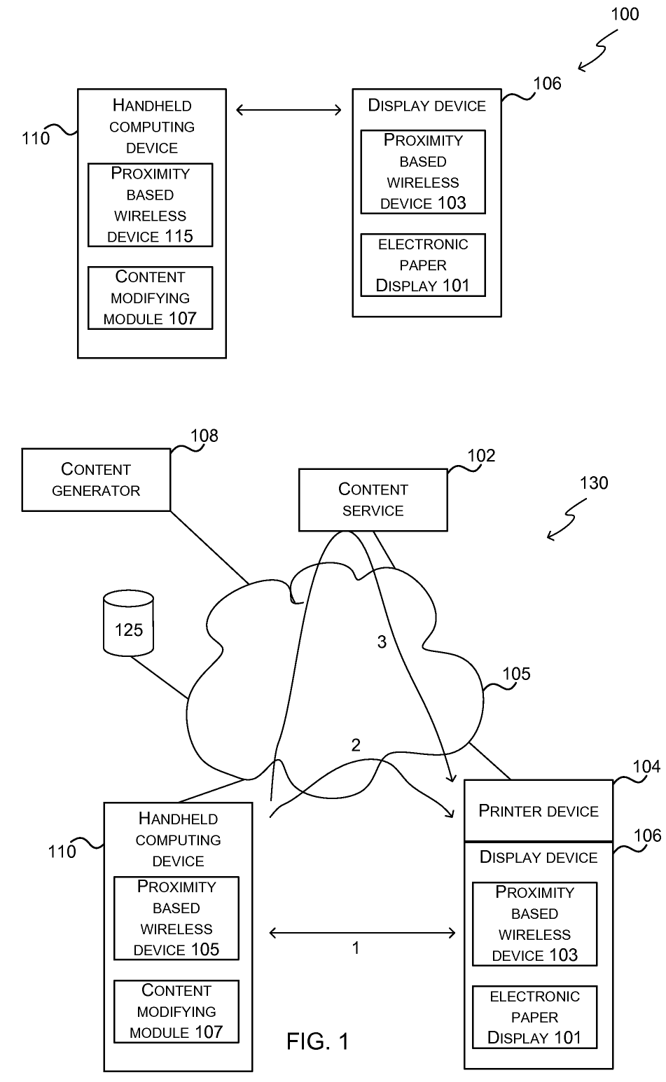

FIG. 1 shows a schematic diagram of a first example system 100 which comprises a computing device 110 (which may be a handheld computing device) and a display device 106 which comprises an electronic paper display 101. Both devices 106, 110 comprise a proximity based wireless device 103, 115 and although these two proximity based wireless devices 103, 115 can communicate, the capabilities of these two devices may be different, e.g. the proximity based wireless device 103 in the display device 106 may be a tag which stores data that can be read by the proximity based wireless device 115 in the handheld computing device 110; however, in various examples, the proximity based wireless device 103 in the display device 106 may not be able to act as a reader and read data from other proximity based wireless devices (including proximity based wireless device 115).

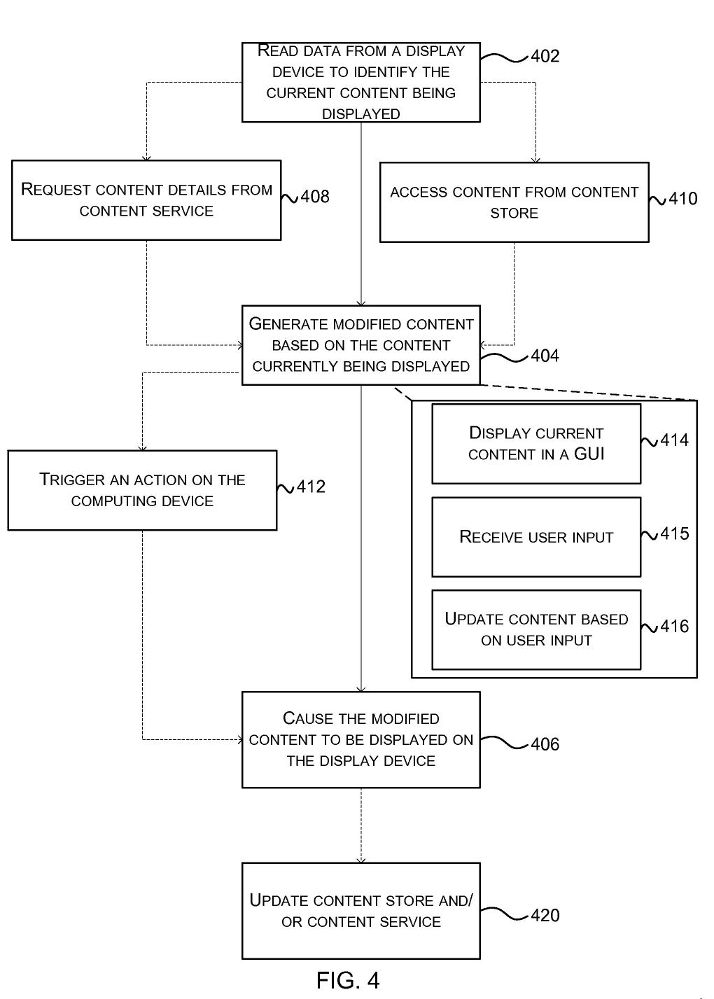

The computing device 110 (which may be handheld/portable) also comprises a content modifying module 107 (which may, for example, be implemented as a software application running on an operating system which runs on the computing device). The content modifying module 107 receives data which has been read from the display device 106 (using the proximity based wireless device 115) where this data identifies the current content being displayed on the electronic paper display 101. The content modifying module 107 then generates modified content based on the identified current content and causes this modified content to be displayed back on the electronic paper display 101 (e.g. to replace the identified current content). In various examples, the modified content may be written back to the display device 106 using the proximity based wireless devices 103, 115 and in other examples, alternative communication means may be used, e.g. as shown in the second example system 130 in FIG. 1. The operation of the content modifying module 107 is described in more detail below with reference to FIGS. 4-9.

FIG. 1 also shows a schematic diagram of a second example system 130 which comprises a computing device 110 (which may be a handheld computing device) and a display device 106 which comprises an electronic paper display 101. As described above, both devices 106, 110 comprise a proximity based wireless device 103, 115 and although these two proximity based wireless devices 103, 115 can communicate (as indicated by arrow 1), the capabilities of these two devices may be different.

In the second example system 130 the computing device 110 is connected to a network 105 (e.g. the internet) and the display device 106 is connected to the network 105 via a printer device 104. In this example, the display device 106 does not comprise a battery (or other power source) which is capable of updating the electronic paper display 101 and consequently the electronic paper display 101 can only be updated when the display device 106 is in contact with the printer device 104. The printer device 104 provides power to the display device 106 to enable the electronic paper display 101 to be updated and also uploads content to the display device 106 (for rendering on the electronic paper display 101). The content that is uploaded may be received from the handheld computing device 110 (as indicated by arrow 2) and/or a content service 102 attached to the network 105 (as indicated by arrow 3).

As also shown in the second example system 130, the system may further comprise a content generator device 108 (which generates content, e.g. under the control of a user). The content which is generated by the content generator 108 may be stored in an accessible location connected to the network 105 (e.g. in a cloud-based content store 125).

Whilst the content generator 108 and content service 102 are shown separately in FIG. 1, in some examples, the content service 102 may also act as the content generator device 108 (e.g. a single application may enable a user to generate, or compile, content and then send the content to a printer device 104 for uploading to a display device comprising an electronic paper display). Similarly, the handheld computing device 110 may also act as the content generator 108. Additionally, although the content store 125 is shown separately from the handheld computing device 110, the content generator 108 and the content service 102, in some examples, the content store 125 may be collocated with the content generator 108 (e.g. it may be part of the content generator device 108) and/or the content service 102 (e.g. it may be part of the device which runs the content service). In an example, an application running on the handheld computing device 110 may act as the content generator 108 and content service 102 and a memory on the handheld computing device 110 may be the content store 125. Furthermore, although FIG. 1 shows a single content store 125, it will be appreciated that there may be more than one content store (e.g. a content store on the content generator 108, a separate content store, a content store on the handheld computing device 110, etc.).

As described above, in various examples (such as in system 130 shown in FIG. 1) the display device 106 (which includes the electronic paper display 101) does not include a battery (or other power source) which provides sufficient power to update the electronic paper display. Instead, power to update the electronic paper display is provided to the display device via a contact based conductive digital data and power bus from the printer device when the display device is touched against the printer device. The digital data and power bus is described as being contact based and conductive because signals for the digital data and power bus are not provided via a cable (which may be flexible), but instead the display device comprises a plurality of conductive contacts (e.g. metal contacts) on its housing (e.g. on an exterior face of the housing) which can be contacted against a corresponding set of conductive contacts on the housing of a printer device. For example, the plurality of conductive contacts may be on a visible face of the display device (e.g. the front, back or side of the printer device) and may be contacted against a corresponding set of conductive contacts on a visible face of the printer device or within a recess (e.g. a slot) on the printer device, such that an edge of the display device is pushed into the recess so that the contacts on the printer and display devices can make contact with each other. The display device is not permanently connected to a printer device but is, instead, intermittently connected (e.g. hourly, daily, weekly, or any other period depending on when new content is desired or available) by a user.

In a variation of the display device 106 described above, data and power may instead be provided via a wired connection (e.g. a USB connection) from a printer device, where the wired connection may be via a flexible cable or a rigid connector which is integrated with the display device.

It will be appreciated that the system may alternatively comprise a display device that does include a battery (or other power source) to provide sufficient power to update the electronic paper display 101 (e.g. as in system 100 shown in FIG. 1). In such examples, the printer device 104 shown in system 130 may be omitted (as in system 100) and the content may be transmitted directly to the display device for rendering (e.g. from the handheld computing device 110 and/or content service 102).

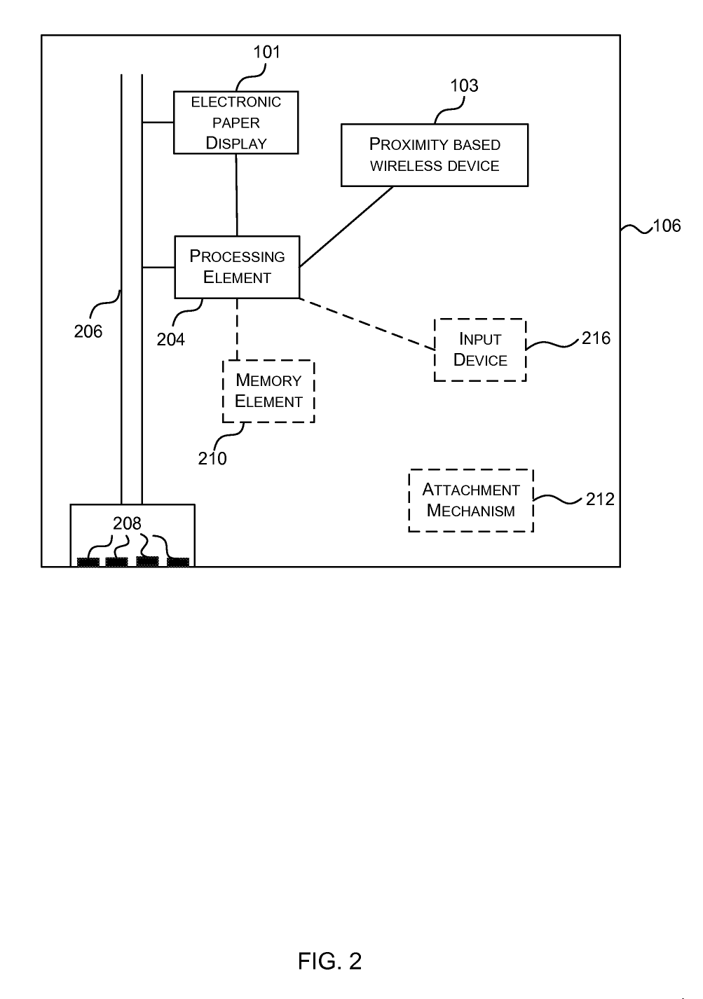

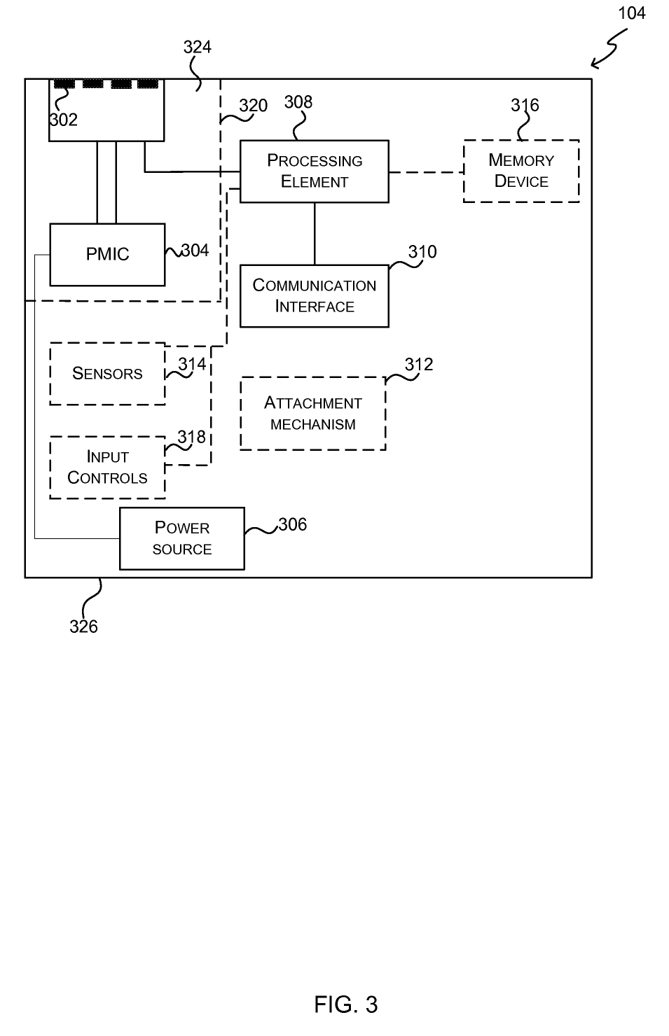

FIG. 2 is a schematic diagram showing an example implementation of the display device 106 from system 130 in more detail and FIG. 3 is a schematic diagram showing the printer device 104 from system 130 in more detail.

The display device 106 comprises an electronic paper display 101, a proximity based wireless device 103, a processing element 204 and a contact based conductive digital data and power bus 206. As described above, the bus 206 connects the processing element 204 to a plurality of conductive contacts 208 on the exterior of the housing of the display device 106. The display device 106 does not comprise a power source which is capable of updating the electronic paper display 101 and power for updating the electronic paper display is instead provided via the bus from a power source 306 in the printer device 104.

As shown in FIG. 2, the display device 106 comprises a proximity based wireless device 103, such as a near field communication (NFC) device or short-range communication devices using other technologies (e.g. short-range optical communication or sound pressure wave communication). The proximity based wireless device 103 comprises a data communication interface (e.g. an I²C interface, SPI, an asynchronous serial interface, etc.) and an antenna and may also comprise a memory device. The memory in the proximity based wireless device 103 (or memory element 210) may be used to store data identifying the current content being displayed on the electronic paper display and this data may be an identifier for the content (a content ID), an address (e.g. URL) identifying the storage location for the currently displayed content (e.g. in content store 125) or the content itself. In other examples, the data may be an identifier for the display device and this may enable a receiving device (e.g. handheld computing device 110) to identify the current content being displayed by sending a request to the content service 102 including the device ID. As described above, the data identifying the current displayed content may be read (via the antenna) by another proximity based wireless device which is in proximity to the display device 106 (e.g. an NFC reader which may be integrated within the handheld computing device 110 or within an accessory/peripheral to the handheld computing device 110, such as a wearable device which acts as an accessory to the handheld computing device and includes an NFC reader). When the displayed content changes, the stored data identifying the current displayed content may also change (e.g. unless the data only identifies the display device).

The memory in the proximity based wireless device 103 may store additional data, such as an identifier (ID) which corresponds to an ID for the display device 106 (where an alternative identifier is used for the content) and in various examples, the memory may store an ID which comprises an element that is fixed and corresponds to a device ID and an element that is dynamic and corresponds to the content currently being displayed on the display device 106. The ID (or part thereof) that identifies the currently displayed content may be written by the processing element 204 whenever new content is rendered on the display. Where the ID includes a session ID, this may be written by the processing element 204 at the start of each new session (e.g. when the processing element switches on). In other examples, the memory may also be used to store operational parameters for the display device (e.g. as described above).

Although the display device 106 comprises a proximity based wireless device 103, in this example implementation (as shown in system 130) this wireless device is not used to provide power to update the electronic paper display 101 (i.e. energy harvesting is not used to provide power to update the electronic paper display). However, it will be appreciated that in other implementations (e.g. that shown in system 100), energy harvesting may be used.

The electronic paper display 101 may use any suitable technology, including, but not limited to: electrophoretic displays (EPDs), electro-wetting displays, bi-stable cholesteric displays, electrochromic displays, MEMS-based displays, and other display technologies. Some of these technologies may provide multi-stable displays. In various examples, the display has a planar rectangular form factor; however, in other examples the electronic paper display 101 may be of any shape and in some examples may not be planar but instead may be curved or otherwise shaped (e.g. to form a wearable wrist-band or to cover a curved object such as the side of a vehicle, a curved wall of a kiosk, or a product container). In various examples, the electronic paper display 101 may be formed on a plastic substrate which may result in a display device 106 which is thin (e.g. less than one millimeter thick) and has some flexibility. Use of a plastic substrate makes the display device 106 lighter, more robust and less prone to cracking of the display (e.g. compared to displays formed on a rigid substrate such as silicon or glass).

The processing element 204 may comprise any form of active (i.e. powered) sequential logic (i.e. logic which has state), such as a microprocessor, microcontroller, shift register or any other suitable type of processor for processing computer executable instructions to drive the electronic paper display 101. The processing element 204 comprises at least the row and column drivers for the electronic paper display 101. However, in various examples, the processing element 204 comprises additional functionality/capability. For example, the processing element 204 may be configured to demultiplex data received via the bus 206 and drive the display 101.

In various examples the processing element 204 may comprise one or more hardware logic components, such as Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs) and Graphics Processing Units (GPUs).

In various examples, the processing element 204 may comprise (or be in communication with) a memory element 210 which is capable of storing data for at least a sub-area of the display 101 (e.g. one row and column of data for the display 101) and which in some examples may cache more display data. In various examples the memory element 210 may be a full framebuffer to which data for each pixel is written before the processing element 204 uses it to drive the row and column drivers for the electronic paper display. In other examples, the electronic paper display may comprise a first display region and a second display region which may be updated separately (e.g. the second display region may be used to show icons or user-specific content) and the memory element may be capable of storing data for each pixel in one of the display regions.

In various examples, the memory element 210 may store other data in addition to data for at least a sub-area of the display 101 (e.g. one row and column of the display). In various examples, the memory element 210 may store an identifier (ID) for the display device 106. This may be a fixed ID such as a unique ID for the display device 106 (and therefore distinct from the IDs of all other display devices 106) or a type ID for the display device (e.g. where the type may be based on a particular build design or standard, electronic paper display technology used, etc.). In other examples, the ID may be a temporary ID, such as an ID for the particular session (where a session corresponds to a period of time when the display device is continuously connected to a particular printer device) or for the particular content being displayed on the display device (where the ID may relate to a single page of content or a set of pages of content or a particular content source). In various examples, a temporary ID may be reset manually (e.g. in response to a user input) or automatically in order that a content service does not associate past printout events on a display device with current (and future) printouts, e.g. to disable the ability for a user to find out the history of what was displayed on a display device which might, for example, be used when the display device is given to another user. The ID which is stored may, for example, be used to determine what content is displayed on the display device (as described in more detail below) and/or how that content is displayed.

In various examples, the memory element 210 may store parameters relating to the electronic paper display 101 such as one or more of: details of the voltages required to drive it (e.g. the precise value of a fixed common voltage, Vcom, which is required to operate the electronic paper display), the size and/or the resolution of the display (e.g. number of pixels, pixel size or dots per inch, number of grey levels or color depth, etc.), temperature compensation curves, age compensation details, update algorithms and/or a sequence of operations to use to update the electronic paper display (which may be referred to as the ‘waveform file’), a number of update cycles experienced, other physical parameters of the electronic paper display (e.g. location, orientation, position of the display relative to the device casing or conductive contacts), the size of the memory element, parameters to use when communicating with the electronic paper display. These parameters may be referred to collectively as ‘operational parameters’ for the electronic paper display. The memory element 210 may also store other parameters which do not relate to the operation of the electronic paper display 101 (and so may be referred to as ‘non-operational parameters’) such as a manufacturing date, version, a color of a bezel of the display device, and other parameters.

Where the memory element 210 stores an ID or parameters for the electronic paper display, any or all of the stored ID and parameters may be communicated to a connected printer device 104 via the bus 206 and contacts 208 by the processing element 204. The printer device 104 may then use the data received to change its operation (e.g. the voltages provided via the bus or the particular content provided for rendering on the display) and/or to check the identity of the display device 106. The ID may in addition, or instead, be communicated to the content service 102 or to a proximate computing device 110 (as described in more detail below).

In various examples, the memory element 210 may store computer executable instructions which are executed by the processing element 204 (when power is provided via the bus 206). The memory element 210 includes volatile and non-volatile, removable and non-removable computer storage media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media.

In various examples, the display device 106 may further comprise an attachment mechanism 212 which is configured to hold the display device 106 in contact with a printer device when a user has brought the two devices into contact with each other. This attachment mechanism 212 may, for example, use one or more ferromagnetic elements in one or both of the display device 106 and the printer device 104. In addition to, or instead of, using ferromagnetic elements, the attachment mechanism may use suction cup tape, friction (e.g. with the display device being partially inserted into a slot or recess on the printer device) or a clamping arrangement.

In various examples, the display device 106 may further comprise one or more input devices 216. An input device 216 may, for example, be a sensor (such as a microphone, touch sensor or accelerometer) or button. Such input devices 216 are only operational (i.e. powered) when the display device 106 is in contact with a printer device 104 such that power is provided via the bus 206. Where the display device 106 comprises an input device 216, signals generated by the input device 216 may be interpreted by the processing element 204 and/or communicated to a remote processing device (e.g. in a printer device 104). User inputs via an input device 216 may, for example, be used to modify the content displayed on the electronic paper display 101 (e.g. to annotate it, change the font size, trigger the next page of content to be displayed, etc.) or to trigger an action in a remote computing device.

In an example, the display device 106 comprises an input device 216, which is a touch-sensitive overlay for the electronic paper display 101. The touch-sensitive overlay may, for example, use pressure, optical, capacitive or resistive touch-sensing techniques. When the display device 106 is powered via the bus (i.e. when it is in contact with a printer device 104), the touch-sensitive overlay may be active and capable of detecting touch events (e.g. as made by a user's finger or a stylus touching the electronic paper display 101). The output of the touch-sensitive overlay is communicated to the processing element 204 or printer device or content service which may modify the displayed image (on the electronic paper display 101) to show marks/annotations which correspond to the touch events. In other examples, the processing element 204 may modify the displayed image in other ways based on the detected touch-events (e.g. through the detection of gestures which may, for example, cause a zoom effect on the displayed content).

In another example, the display device 106 comprises an input device 216 which is a microphone. The microphone detects sounds, including speech of a user and these captured sounds may be detected by the processing element 204 or printer device or content service and translated into changes to the displayed image (e.g. to add annotations or otherwise change the displayed content). For example, keyword detection may be performed on the processing element to cause it to fetch content from memory and write it to the electronic paper display. In another example, the processing element may interpret or transform the audio data and send it to the printer device or a remote server for more complex processing. In another example, the recorded sounds (e.g. speech waveform) may be recorded and stored remotely (e.g. in a content service) associated with the ID of the display device and a visual indication may be added to the displayed content so that the user knows (e.g. when the user views the same content later in time) that there is an audio annotation for the content.

In various examples, the display device 300 may comprise a touch-sensitive overlay and a microphone that operate in combination to enable a user to use touch (e.g. with a finger or stylus) to identify the part of an image (or other displayed content) to annotate, and also to enable a user to annotate the image with a voice message as captured via the microphone. In such an example, the voice message may be translated to text that is added to the displayed content, or may be interpreted as a command, e.g. “delete this entry” to affect the content of the image. In other implementations, the voice message may be stored as an audio file associate with the image, and may be played back when a user activates a user-interface on the display.

The printer device 104 comprises a plurality of conductive contacts 302 and a power management IC (PMIC) 304 which generates the voltages that are provided to bus of the display device (via contacts 302). The PMIC 304 is connected to a power source 306 which may comprise a battery (or other local power store, such as a fuel cell or supercapacitor) and/or a connection to an external power source. Alternatively, the printer device 104 may use an energy harvesting mechanism (e.g. a vibration harvester or solar cell).

The printer device 104 further comprises a processing element 308 which provides the data for the bus of the display device, including the pixel data. The processing element 308 in the printer device 104 obtains content for display from the content service 102 via a communication interface 310 and may also obtain one or more operational parameters for different display devices from the content service 102. The communication interface 310 may use any communication protocol and in various examples, wireless protocols such as Bluetooth™ or WiFi™ or cellular protocols (e.g. 3G or 4G) may be used and/or wired protocols such as USB or Ethernet may be used. In some examples, such as where the communication interface uses USB, the communication interface 310 may be integrated with the power source 306 as a physical connection to the printer device 104 may provide both power and data.

The processing element 308 may, for example, be a microprocessor, controller or any other suitable type of processor for processing computer executable instructions to control the operation of the printer device in order to output pixel data to a connected display device 106. In some examples, for example where a system on a chip architecture is used, the processing element 308 may include one or more fixed function blocks (also referred to as accelerators) which implement a part of the method of providing pixel data in hardware (rather than software or firmware). The processing element 308 may comprise one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

The printer device 104 may comprise an attachment mechanism 312, such as one or more ferromagnetic elements or a slot to retain the display device. This attachment mechanism 312 may, in various examples, incorporate a sensor 314 (which may be implemented as a sensing electronic circuit) to enable the printer device 104 to determine the orientation of a display device when in contact with the printer device 104 and/or whether a display device is in contact or not.

In various examples, the processing element 308 may comprise (or be in communication with) a memory device (or element) 316. In various examples, the memory element 316 may store an identifier (ID) for the printer device 104. This may be a fixed ID such as a unique ID for the printer device 104 (and therefore distinct from the IDs of all other printer devices 104) or a type ID for the printer device (e.g. where the type may be based on a particular build design or standard.). In other examples, the ID may be a temporary ID, such as an ID for the particular session (where a session corresponds to a period of time when the display device is continuously connected to a particular printer device) or for the particular content being displayed on a connected display device (where the ID may relate to a single page of content or a set of pages of content or a particular content source).

In various examples, the memory element 316 may store operational parameters for one or more different electronic paper displays, where these operational parameters may be indexed (or identified) using an ID for the display device (e.g. a unique ID or a type ID). Where operational parameters are stored in the memory element 316 these may be copies of parameters which are stored on the display device, or they may be different parameters (e.g. voltages may be stored on the display device and a waveform for driving the display device may be stored on the printer device because it occupies more memory than the voltages) or there may not be any operational parameters stored on the display device. In addition, or instead, the memory element may store parameters associated with printer device, such as its location (e.g. kitchen, bedroom, etc.) and additional connected devices (e.g. a music player through which audio can be played, etc.).

In various examples, the memory element 316 may act as a cache for the content (or image data) to be displayed on a connected display device. This may, for example, enable content to be rendered more quickly to a connected device (e.g. as any delay in accessing the content service 102 may be hidden as pages are cached locally in the memory element 316 and can be rendered whilst other pages are being accessed from the content service 102) and/or enable a small amount of content to be rendered even if the printer device 104 cannot connect to the content service 102 (e.g. in the event of connectivity or network problems).

The memory element 316 may, in various examples, store computer executable instructions for execution by the processing element 308. The memory element 316 may include volatile and non-volatile, removable and non-removable computer storage media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 316) is shown within the printer device 104 it will be appreciated that the storage may be distributed or located remotely and accessed via a network or other communication link (e.g. using communication interface 310).

As described above, the printer device 104 may comprise a sensor 314 configured to detect whether a display device is in contact with the printer device 104 or is electrically connected via the contacts 302. In addition or instead, one or more other sensors may be provided within the printer device 104, such as an accelerometer (e.g. for sensing motion of or the orientation of the printer device 104) and/or a sensor for detecting a proximate handheld computing device (e.g. a smartphone or tablet computer).

In various examples, the printer device 104 may comprise one or more user input controls 318 which are configured to receive user inputs. These user inputs may, for example, be used to change what is displayed on a connected display device (e.g. to select the next page within a piece of content or the next piece of content). For example, the printer device 104 may comprise one or more physical buttons. In various examples, one or more physical buttons may be provided which are mapped to specific content (e.g. when pressing a particular button, a photo ID badge will always be rendered on the connected display). These buttons may have fixed functions or their functions may change (e.g. based on the content displayed or the display device connected). In some examples, the processing element 308 may render icons adjacent to each button on the electronic paper display, where an icon indicates the function of the adjacent button. In such an example, the pixel data provided to the display device (via contacts 302) is a composite image which combines the content to be displayed and one or more icons for buttons (or other physical controls) on the printer device 104. In other examples, the composite image may be generated by the content service 102.

In an example, the printer device 104 comprises an input control (or device) 318 which detects a user touching a connected display device with their finger or a stylus. This may, for example, comprise an electromagnetic sensing backplane (e.g. using electric field sensing) in the face of the printer device which is adjacent to a connected display device or may be implemented using force sensors (e.g. four sensors at the corners and where interpolation is used to calculate the touch point position) or active digitizer pens. Alternatively, optical or ultrasonic methods may be used (e.g. to look along the top surface. Where ultrasonics are used, these may additionally be used to provide haptic feedback to the user. The output of the touch input control is communicated to the processing element 308 or to the content service which may modify the content and then provide the modified content to the display device (so that it is displayed on the electronic paper display 106) to show marks/annotations which correspond to the touch events. In other examples, the processing element 308/content service may modify the displayed image in other ways based on the detected touch-events (e.g. through the detection of gestures which may, for example, cause a zoom effect on the displayed content or through provision of feedback in other ways, e.g. using audio or vibration or by selectively backlighting the electronic paper display using one or more lightpipes).

In various examples, the printer device 104 comprises an input device which is a microphone. The microphone detects sounds, including speech of a user and these captured sounds may be detected by the processing element or content service and translated into changes to the displayed image (e.g. to add annotations or otherwise change the displayed content). In another example, the recorded sounds (e.g. speech waveform) may be recorded and stored remotely (e.g. in a content service) associated with the ID of the display device and a visual indication may be added to the displayed content so that the user knows (e.g. when they view the same content at a later time) that there is an audio annotation for the content.

In various examples, the printer device 104 may comprise a sensing backplane and a microphone that operate in combination to enable a user to use touch (e.g. with a finger or stylus) to identify the part of an image (or other displayed content) to annotate and then their voice to provide the annotation (as captured via the microphone). In such an example, the spoken words may be text to add to the displayed content or commands (e.g. “delete this entry”).

The printer device 104 may have many different form factors. In various examples it is standalone device which comprises a processing element 308 and communication interface 310 in addition to a PMIC 304 and a plurality of conductive contacts 302 to provide the signals for the digital data and power bus 206 within a display device. In other examples, however, it may be a peripheral for a computing device and may utilize existing functionality within that computing device which may, for example, be a portable or handheld computing device (e.g. a smartphone, tablet computer, handheld games console, etc.) or a larger computing device (e.g. a desktop computer or non-handheld games console). Where the printing device 104 is implemented as a peripheral device, the functionality shown in FIG. 3 may be split along the dotted line 320 such that the PMIC 304 and conductive contacts 302 are within the peripheral 324 and the remaining elements (in portion 326) are within the computing device and may utilize existing elements within that computing device. In further examples, the entire printer device 104 may be integrated within a computing device.

FIG. 4 is a flow diagram showing an example method of operation of the computing device 110 comprising the content modifying module 107 as shown in FIG. 1. The method comprises reading data from the display device 106 using proximity based wireless networking (e.g. using proximity based wireless device 115) where the data that is read identifies the current content being displayed on an electronic paper display 101 within the display device 106 (block 402). The data which is read (in block 402) may comprise the content being displayed or may be an identifier which enables the current content to be accessed from another location, e.g. from content service 102 or content store 125. Consequently, the method may further comprise requesting content details from the content service 102 using the data read from the display device 106 (block 408) and/or accessing the content from the content store 125 using the data read from the display device (block 410).

In various examples, the data is read from the display device 106 (in block 402) via a proximity based wireless network devices 103, 115 in the display device 106 and the handheld computing device 110 respectively. As described above, however, in some examples the proximity based wireless device 115 may be located in a peripheral or accessory that is connected to the handheld computing device 110 (e.g. a wearable accessory such as a smart watch or ear piece). Similarly, in some examples the proximity based wireless device 103 may not be in the display device 106 but in a device to which the display device is connected (e.g. a printer device 104).

Having identified the content which is currently being displayed on the electronic paper display 101 (in blocks 402, 408, 410), the method comprises generating modified content based on the content currently being displayed (block 404) and as described above this may be implemented by the content modifying module 107 on the computing device 110 either automatically or with some user input. The modified content which is generated (in block 404) may be partially the same as the original content (i.e. the content currently being displayed on the electronic paper display 101 as identified in block 402) or may be completely different from the original content, whilst still being generated based on that original content. The modified content may also be referred to as derived content. Various examples of the way the modified content may be generated are described below. A content modifying module 107 may implement any one or more of these examples.

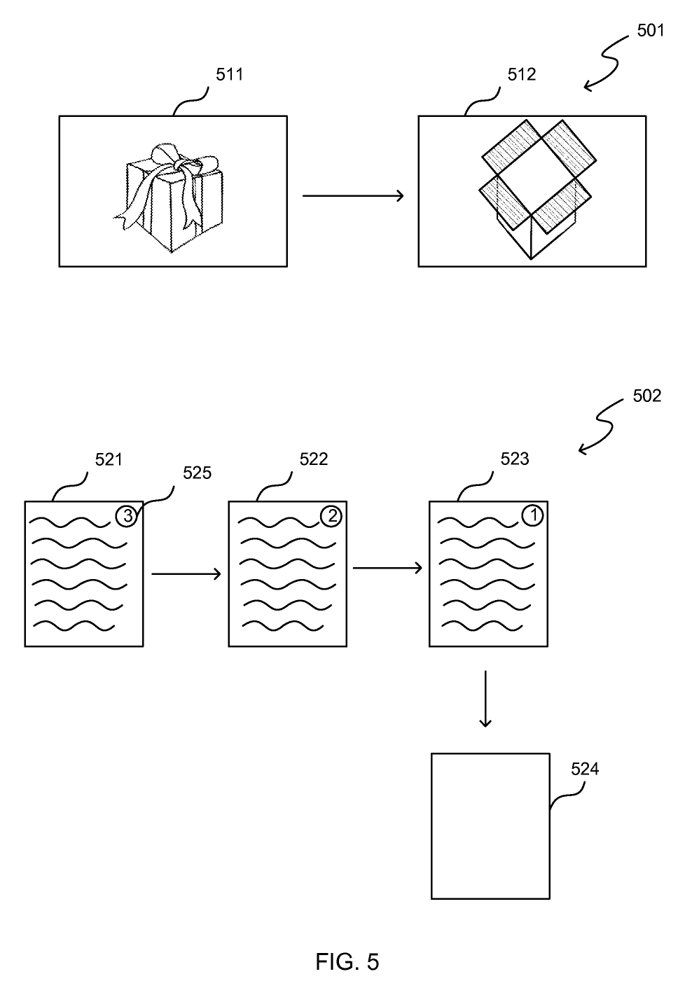

In a first example, the content may be modified (in block 404) automatically according to a pre-defined sequence. For example, an item of content may have an associated state and may be displayed differently based on that associated state, as can be described with reference to FIG. 5. In the first example 501, an item of content may have two pre-defined states 511, 512. If the data which is read from the display device (in block 402) indicates that the current content being displayed is the first state 511 of the two pre-defined states, then the modified content which is generated (in block 404) corresponds to the second state 512 of the two pre-defined states. In this example, the changing of the content (from state 511 to state 512) depicts the opening of a gift and in addition to modifying the content (in block 404), the reading of the data (in block 402) may also trigger an action on the computing device 110 (block 412), such as the downloading or opening of a file (e.g. a music or video file, or an application.). Details of the action may also be read from the display device (in block 402) or alternatively, this may be provided by the content service 102 or other remote entity in response to a request sent by the computing device 110 which includes data received from the display device (e.g. as sent in block 408).

Although FIG. 4 shows the action being triggered on the computing device 110, in other examples it may be triggered on a nearby (or proximate) device (e.g. a television). In some examples, different actions may be triggered depending upon the computing device 110 or the printer device 104 to which a display device 106 is connected.

In the second example 502 in FIG. 5, an item of content may have four pre-defined states 521-524. In all but the final state 524, the content is the same except for a number 525 which indicates the number of times the content can be viewed and in each state this number decrements until in the final state 524, the content is no longer visible (e.g. the content has been replaced by a white/black page, become blurred or otherwise been rendered unreadable). It will be appreciated that while this second example uses a number to indicate visually that the content has limited life, this may alternatively be represented in different ways (e.g. with the content becoming gradually fainter in each pre-defined state until it becomes unreadable/invisible without explicitly indicating a number of times it can be viewed). Using this technique, the content displayed on an electronic paper device 101 may automatically self-destruct after it has been viewed a pre-defined number of times (where in some examples this pre-defined number of times may only be a single viewing). This can be used as a security mechanism to protect the content being displayed, for example if the content is sensitive in nature (e.g. if it comprises personal data).

In some examples, the generation of modified content (in block 404) may be based on one or more additional parameters in addition to being based on the currently displayed content. An example of such an additional parameter is the number of views (as described above). Another example of an additional parameter on which the generation of modified content may, in part, be based, is the current date and/or time. Use of the date and/or time as an additional parameter enables the content modifying module 107 to be used to erase content when an expiry date and/or time has passed.

Although in the first example described above, the modified content may be generated by the content modifying module 107, in other examples the modified content may be generated on the display device (e.g. according to a program stored on the display device) and the generation of the modified content on the display device may be based on a change of state which is communicated to the display device by the handheld computing device 110 (e.g. by the content modifying module 107).

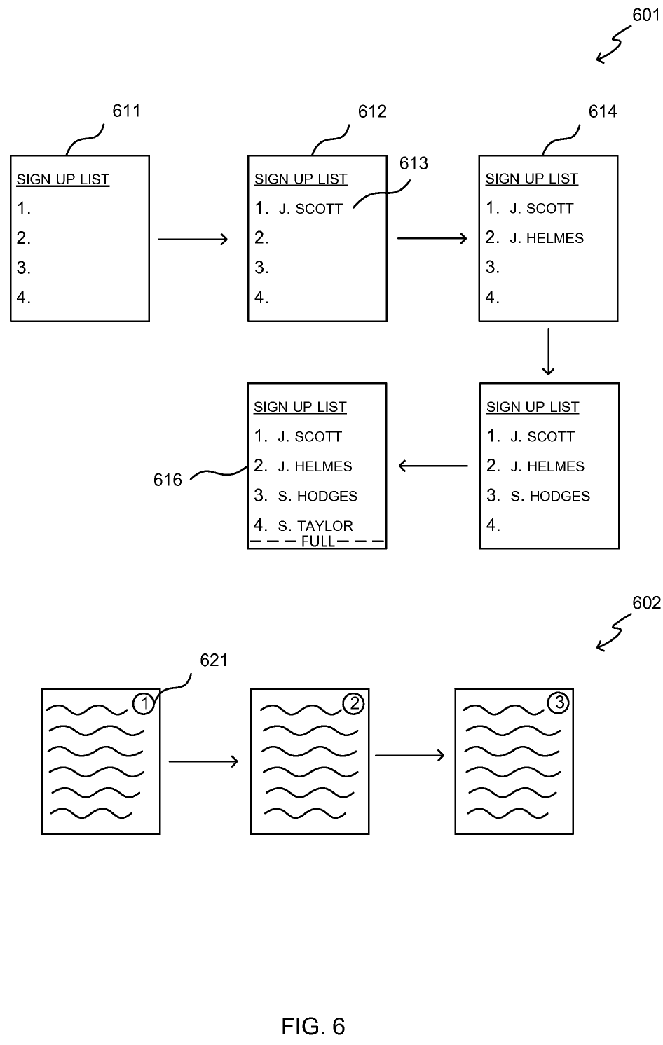

In a second example, the content may be modified (in block 404) automatically in a pre-defined way (e.g. so that the same modification action is performed each time, although the starting content may be different). This is not the same as the first example, as the exact modified content is not pre-defined. However, the way that the modified content is generated is pre-defined. For example, the content may be modified by adding an additional element to the content and/or by removing an element from the content and various examples are shown in FIG. 6. The first example 601 shown in FIG. 6 is an automatic sign-up sheet and the first image is of a blank sign-up sheet 611, which may be initially identified (in block 402) as the current content being displayed on a display device when a first user brings a computing device into proximity with the display device. This results in the generation of modified content 612 (in block 404) which comprises the original content 611 with the addition of the first user's name 613. The modified content 612 is then displayed on the display device (as a consequence of block 406 and as described in more detail below). If a second user subsequently brings their computing device into proximity with the same display device (which is now displaying content 612), the content which is identified by the data read from the display device (in block 402) is the content 612 with the first user's name on it. Again modified content 614 is generated (in block 404) by adding a user's name to the content (this time the second user's name is added). As shown in FIG. 6, there may be a limit on the number of times that the content can be updated, for example, when the sign up list becomes full (as shown by modified content 616) and after this threshold is reached, it may not be possible to generate further modified content even if another user brings their computing device into proximity with the display device.

In the first example 601 in FIG. 6 the user's name may be known by the computing device which modifies the content (and performs block 404) because a user may have specified it within the content modifying application 107 or this data may be stored elsewhere in the computing device. In other examples, the data which is added may be another property of the handheld computing device (e.g. a unique identifier associated with the device, the device's telephone number, the location of the device at the time the modification is made, a current mode of operation of the handheld computing device, etc.). In a variation on this example, names may be removed from a displayed list instead of being added.

A second example 602 shown in FIG. 6 is similar to the second example in FIG. 5; however, in this example 602, the number 621 which is added to the content is incremented with each viewing to show the number of times that the content has been viewed. Unlike the example shown in FIG. 5, the different states of the content are not pre-defined but the way that the content is modified each time is pre-defined (e.g. it is not ‘change from image A to image B’ but ‘remove number A from image and replace with number B’).

The modifying of content automatically in a pre-defined way (in block 404) may also be used to implement other features aside from an automatic sign-up sheet (as in example 601) or a count of the number of times content has been viewed (as in example 602). For example, it may be used to automatically update a document with the names of reviewers (who may also be able to add their annotations as described in the next example) and/or names of those who have approved the document (e.g. prior to release of a document). In other examples it may be used to record votes (e.g. the number cast for a particular option and/or the names of those who have voted or have still to vote, with people's names being removed rather than added to a displayed list) or for gaming or mapping applications, for example using computing devices located in fixed positions and which update the content with their location and a time stamp (e.g. in a form of scavenger hunt with competitors racing to collect a certain location stamps on their display device or to generate a map to enable a user to retrace their route at a later time). In a yet further example, it may be used to update a displayed collection of items (e.g. photographs) by adding a new item (e.g. a new photograph) and optionally removing an item (e.g. by removing the oldest photograph to make space for the newly added photograph). In these examples, the item which is added may be associated with or a property of the handheld computing device (e.g. the photograph that was captured or viewed most recently on the handheld computing device or a default image for the handheld computing device).

In various examples, the pre-defined way that the content is modified may be dependent upon a mode of operation of the handheld computing device. For example, one or more computing devices may be configured either in an offline step (i.e. prior to reading data from the display device in block 402), or in an online step (i.e. by making a user input on the device just before placing in proximity to the display device) to perform/trigger particular modifications, e.g. “erase”, “increase/decrease” (for content that includes a quantity level).

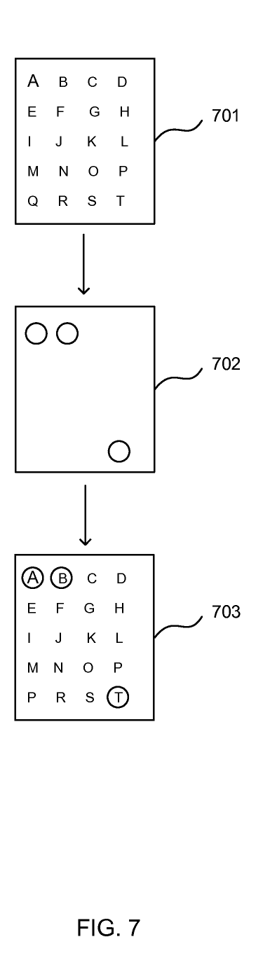

In a third example, the content may be modified (in block 404) based on user input. In this example, generating the modified content may comprise displaying the current content within a graphical user interface (GUI) on the computing device (block 414), receiving a user input (block 415) and updating the content based on the user input (block 416). The user input received may, for example, comprise annotations or amendments to the content that are then added into the content (in block 416) rather than being additional content which is subsequently shown alongside the original content (in the modified content). The user input may be received via any user input device incorporated into (or connected to) the computing device, e.g. a touch-sensitive screen, a camera (e.g. for gesture recognition), a microphone (e.g. where a speech-to-text engine may be used to convert spoken words into annotations), a keyboard, or other input device or input mechanism. An example is shown in FIG. 7 which shows the originally displayed content 701 (as identified by the data received in block 402 and displayed in a GUI in block 414), the user input received 702 (in block 415) and the modified content 703 which combines the original content 701 and the user input 702 (as generated in block 416). In this example, the user input may be received (in block 715) via a touch-sensitive screen with the user using a stylus or their finger to circle letters in the original content when displayed in the GUI on the computing device 110.

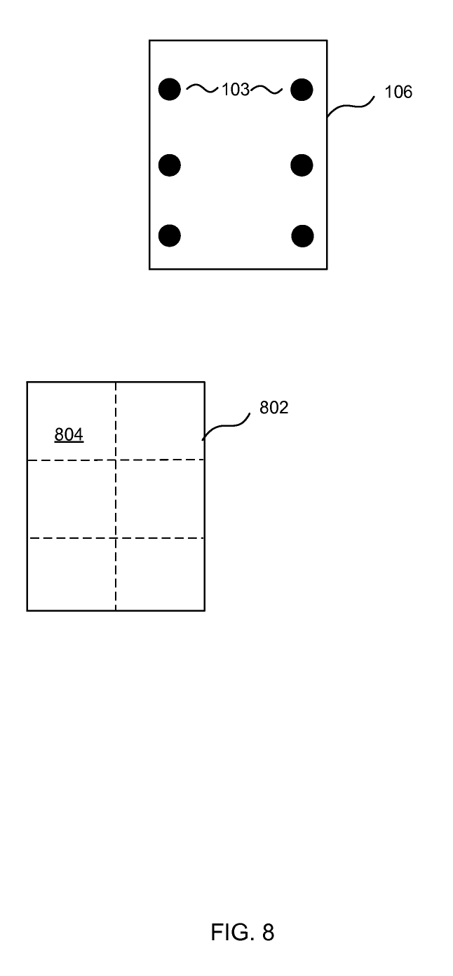

In various examples, the content which can be modified in this third example corresponds to the entire content which is currently being displayed (as identified in block 402). In other examples, however, the display device 106 may comprise a plurality of proximity based wireless devices 103, as shown in FIG. 8, and depending upon which one data is read from (in block 402) a user may be able to modify different parts of the displayed content. In the example shown in FIG. 8, the display device 106 comprises six proximity based wireless devices 103 which are spaced around the display device 106. The content 802 which is displayed on the electronic paper display 101 within the display device 106 is, in this example, logically divided into 6 portions 804 and dependent upon which of the six proximity based wireless devices 103 data is read from (in block 402), the user is able to modify (in block 415) a different portion 804 of the content. This segmenting of the originally displayed content 802 may, for example, be used where the display device 106 is large (e.g. compared to the display of the computing device 110) or is used to display lots of content (e.g. in a small font) which may not be clearly displayed on the display of the computing device 110 if the entire content was displayed at once (and fitted to the size of the display of the computing device 110). It will be appreciated that instead of using multiple proximity based wireless devices 103, the display device 106 may comprise multiple antennas and a single proximity based networking device which cycles around the antennas (thereby reducing cost). In further examples, techniques may be used to interpolate between proximity based wireless devices and/or antennas to determine (or localize) the position of the device reading the data.

Although the example in FIG. 8 shows a fixed segmentation of the displayed content (into six regions), in other examples the portion of the content which is modifiable may be dynamically determined based on a determined position of the computing device relative to the electronic paper display. In such an example, the data received which identifies the content (in block 402) may comprise only the portion that can be modified or may comprise all the content along with data identifying the part which can be modified.

By segmenting the displayed content into smaller regions, the computing device (i.e. the reader device) may be used as a pen input, with the relative location of the computing device and the display device being used to generate a trace or mark on the displayed content when generating the modified content.

Having generated modified content (in block 404), the method further comprises causing the modified content to be displayed on the display device (block 406), i.e. back on the same display device from which the data was read in block 402. There are many different ways in which this may be implemented depending upon the capabilities of the display device 106 and the system in which the display device operates and various examples are described below. In some examples, as well as causing the modified content to be displayed on the electronic paper display 101 (in block 406), the method may also comprise triggering the modified content (or data identifying the modified content) to be stored associated with the proximity based wireless device 103 in the display device 106.

Referring back to the first example system 100 shown in FIG. 1, in this example, the modified content may be written back to the display device 106 by the computing device 110 using the proximity based wireless devices 103, 115. If the display device 106 comprises a battery (or other power source) that is capable of updating the electronic paper display 101 or comprises power harvesting hardware which can harvest sufficient power from the proximity based wireless devices, then the displayed content can then be updated to show the modified content on the electronic paper display 101.

Referring back to the second example system 130 shown in FIG. 1, in this example, the display device 106 does not comprise a battery (or other power source) which is capable of updating the electronic paper display 101 and also does not comprise power harvesting hardware which can harvest sufficient power from the proximity based wireless devices to update the electronic paper display. In this example, the electronic paper display can only be updated when the display device is in contact with a printer device 104 (and is receiving power via the contact-based bus, as described above with reference to FIGS. 2 and 3). In this system 130, the modified content may be provided to the display device 106 directly (using the proximity based wireless devices, arrow 1), via the printer device 104 (arrow 2) or via the content service 102 and the printer device 104 (arrow 3). In examples where the content is provided via the proximity based wireless devices (arrow 1), the displayed content is not immediately updated (such that the modified content is visible), because the electronic paper display cannot be updated until the display device 106 is brought into contact with a printer device 104.

In examples where the content is provided via a printer device 104, the modified content may be uploaded to the display device 106 via the contact-based bus (as described above) and can be displayed immediately (as power is also being provided via that contact-based bus). In examples where the printer device 104 also comprises a proximity based wireless device (not shown in FIG. 3), the content may be uploaded to the display device 106 using this proximity based wireless device and then can be displayed immediately as long as the printer device and display device are in contact such that power is being provided to the display device via the contact-based bus 206.

Although in the examples described above, the entire modified content is provided to the display device (in block 406), in other examples the content modifying module 107 may provide a script which the display device uses to locally regenerate the modified content. The script that is provided to the display device may, for example, be smaller in size than the resultant modified content. In other examples, the content may be provided as a differential format, i.e. where only the differences between the existing content and the new content are transmitted, saving on network bandwidth and energy, and also allowing the display to be updated in a more efficient way (only updating the necessary parts of the display, which results in faster and more energy efficient updates particularly on EPD or similar displays). In further examples, image-related content which is associated with likely updates may be transferred to the display device in at a prior stage, e.g. at the time the original image was printed on the display device. For example, the font that is used for a sign-up list, or the icons that are used to show that the various approvers for a document have approved it. This may allow the content provided at the actual update time to be reduced, e.g. to just the text of the name to add to the list (because the font is already present).

In addition to causing the modified content to be displayed on the display device (in block 406), the method may also comprise updating the content store 125 and/or content service 102 to reflect the modified content (block 420). This may be performed as part of causing the modified content to be displayed on the display device (e.g. block 420 may be part of block 406) in examples where the content is provided to the display device via the content store 102 (arrow 3 in FIG. 1). However, it may also be performed in examples where the original content was requested from the content service (in block 408) or where the original content was accessed from the content store (in block 410).

As described above with reference to the first example 601 in FIG. 6, in some examples there may be a limit on the permitted modifications that can be made (in block 404). Consequently there may be a check performed (e.g. as part of block 404 or prior to block 404) to determine whether the content currently being displayed can be modified. If it cannot, the method stops at this point (although an action may still be triggered in block 412) and a message may be displayed within a GUI on the computing device indicating that no modification is possible.

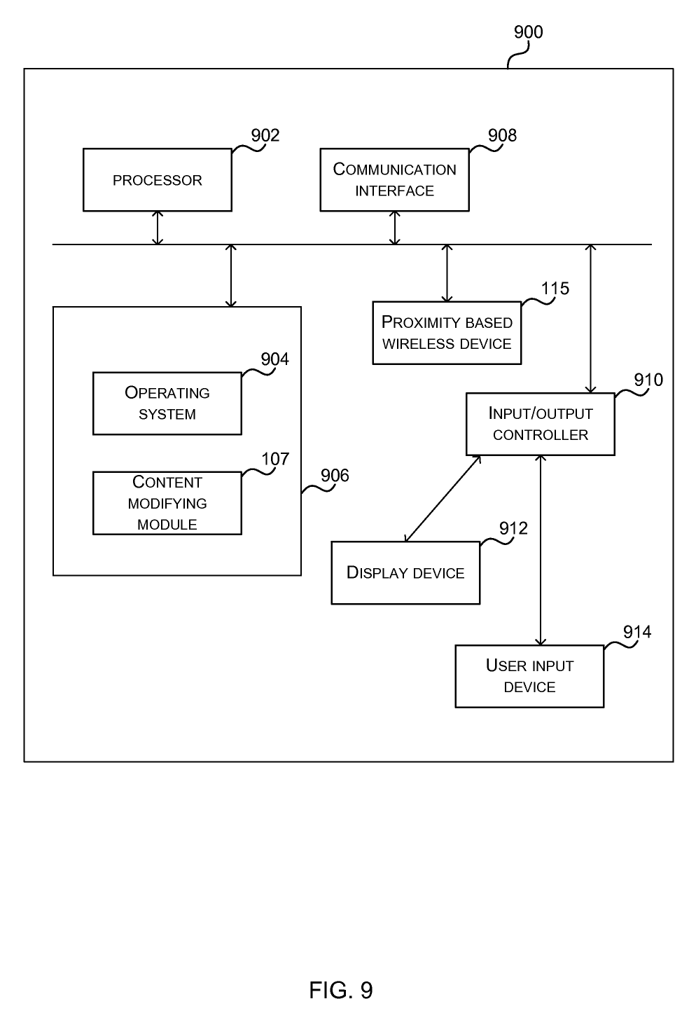

FIG. 9 illustrates various components of an exemplary computing-based device 900 which may be implemented as any form of a computing and/or electronic device, and which may act as computing device 110 as described above and shown in FIG. 1.

Computing-based device 900 comprises one or more processors 902 which may be microprocessors, controllers or any other suitable type of processors for processing computer executable instructions to control the operation of the device in order to implement the method shown in FIG. 4. In some examples, for example where a system on a chip architecture is used, the processors 902 may include one or more fixed function blocks (also referred to as accelerators) which implement a part of the method of FIG. 4 in hardware (rather than software or firmware). Platform software comprising an operating system 904 or any other suitable platform software may be provided at the computing-based device to enable application software, including the content modifying module 107, to be executed on the device.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

The computer executable instructions may be provided using any computer-readable media that is accessible by computing based device 900. Computer-readable media may include, for example, computer storage media such as memory 906 and communications media. Computer storage media, such as memory 906, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 906) is shown within the computing-based device 900 it will be appreciated that the storage may be distributed or located remotely and accessed via a network (e.g. network 105) or other communication link (e.g. using communication interface 908).

The computing-based device 900 further comprises a proximity based wireless device 115, such as an NFC device. As described above, this proximity based wireless device 115 is used to read data from a proximate display device 106 and may also be used to provide the modified content back to the display device. Alternatively, the communication interface 908 may be used to cause transmit the modified content to the content store 125, content service 102, a printer device 104 and/or to the display device 106 directly.

The computing-based device 900 may also comprise an input/output controller 910 arranged to output display information to a display device 912 which may be separate from or integral to the computing-based device 900 and/or to receive and process input from one or more devices, such as a user input device 914 (e.g. a mouse, keyboard, camera, microphone or other sensor). In some examples the user input device 914 may detect voice input, user gestures or other user actions and may provide a natural user interface (NUI). The input/output controller 910 may also output data to devices other than the display device 912.

Any of the input/output controller 910, display device 912 and the user input device 914 may comprise NUI technology which enables a user to interact with the computing-based device 900 in a natural manner, free from artificial constraints imposed by input devices such as mice, keyboards, remote controls and the like. Examples of NUI technology that may be provided include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that may be used include intention and goal understanding systems, motion gesture detection systems using depth cameras (such as stereoscopic camera systems, infrared camera systems, RGB camera systems and combinations of these), motion gesture detection using accelerometers/gyroscopes, facial recognition, 3D displays, head, eye and gaze tracking, immersive augmented reality and virtual reality systems and technologies for sensing brain activity using electric field sensing electrodes (EEG and related methods).

Although the present examples are described and illustrated herein as being implemented in a system as shown in the two examples in FIG. 1, the systems as described are provided as examples and not limitations. As those skilled in the art will appreciate, the present examples are suitable for application in a variety of different types of systems and elements shown in the example systems may be combined (e.g. a computing device may act as a content generator and a printer device or a content service and content generator, etc.). Furthermore, any suitable communication means may be used by the particular elements shown in FIG. 1 to communicate (e.g. point to point links, broadcast technologies, etc.) in place of network 105.

Although in the examples described above, the display device comprises a proximity based wireless device, in other examples, this proximity based wireless device may be replaced by using any location proximity detection method, e.g. using a camera-based system to recognize that the user has touched or has reached towards a specific electronic paper display. The actual data networking may be through other means, e.g. WiFi or Bluetooth Limited Energy or other radio protocol or system. The electronic paper display may be able to convey information back to a portable device using graphical methods. For example, the electronic paper display could display a QR code to be scanned and interpreted by the portable device.

By using the methods described above, a display device which does not comprise (a) a power supply which is capable of providing enough power to update the electronic paper display, (b) input sensors capable of sensing user input, (c) processing power to combine the sensed inputs with the current content to generate modified content and/or (d) the ability to pull in information from other sources and combine it to generate modified content can be made more interactive.

A first further example provides a display device comprising: an electronic paper display; a transmitter configured to transmit data identifying content currently displayed on the electronic paper display; a digital data and power bus arranged to receive pixel data for modified content associated with the transmitted data; and a processor configured to drive the electronic paper display, wherein the electronic paper display can only be updated to display the modified content when receiving power via the digital data and power bus.

In the first further example, the electronic paper display may be a multi-stable display.

In the first further example, the transmitter may be a proximity based wireless device. The proximity based wireless device may be configured to transmit the data identifying the content currently displayed on the electronic paper display to a computing device comprising a second proximity based wireless device.

In the first further example, the modified content associated with the transmitted data may comprise modified content generated based at least in part on the transmitted data.

A second further example provides a computing device comprising: a receiver configured to read data identifying content currently displayed on an electronic paper display; and a processor configured to generate modified content associated with the received data and cause the modified content to be displayed on the electronic paper display.

In the second further example, the electronic paper display may be a multi-stable display.

In the second further example, the modified content associated with the transmitted data may comprise modified content generated based at least in part on the transmitted data.

In the second further example, causing the modified content to be displayed on the electronic paper display may comprise: providing the modified content to the electronic paper display via an electrical contact-based interface.

In the second further example, the processor may be further configured to send a request to a content service for the content currently displayed on the electronic paper display, the request comprising the data read by the receiver.

In the second further example, the processor may be further configured to access the content currently displayed on the electronic paper display from a content store using the data read by the receiver.

In the second further example, the processor may be further configured to trigger an action on the computing device or a proximate device based at least in part on the data read by the receiver. The action may comprise playing or downloading an audio or video file.

In the second further example, the processor may be further configured to generate the modified content based at least in part on the received data and according to a pre-defined sequence.

In the second further example, the processor may be configured to generate the modified content by replacing the content currently displayed with a next content element in a pre-defined sequence of content elements. In the second further example, no content may be visible in a final content element in the pre-defined sequence of content elements.

In the second further example, the processor may be configured to generate the modified content by modifying the content currently displayed in a pre-defined way.

In the second further example, the processor may be configured to generate the modified content by adding an additional element to the content currently displayed. The additional element may comprise a parameter associated with the computing device. The parameter associated with the computing device may comprise one of a user name, a device identifier, a date, a time, a mode of operation and a location of the computing device.

In the second further example, the processor may be configured to generate the modified content based at least in part on the content currently displayed on the electronic paper display and a user input received at the computing device.

In the second further example, the processor may be configured to display the content currently displayed on the electronic paper display in a graphical user interface on the computing device; receive user input via a user input device; and generate modified content by combining the content currently displayed on the electronic paper display and the user input.

In the second further example, the receiver may be a proximity based wireless device and may be configured to read the data identifying content currently displayed on the electronic paper display from a proximity based wireless device in a display device comprising the electronic paper display.

In the second further example, the display device may further comprise a contact based conductive digital data and power bus and a processing element configured to drive the electronic paper display, wherein the electronic paper display can only be updated when receiving power via the bus.

In the second further example, the processor may be configured to transmit the modified content to a printer device, the printer device comprising: a power management device configured to supply at least one voltage for driving the electronic paper display to the contact based conductive digital data and power bus in the display device via one or more contacts on an exterior of the printer device; and a processing element configured to supply pixel data for the electronic paper display, including pixel data for the modified content, to the contact based conductive digital data and power bus via two or more contacts on the exterior of the printer device.

A third further example provides a computer implemented method of updating content displayed on an electronic paper display, the method comprising: reading, by a receiver in a computing device, data identifying content currently displayed on the electronic paper display; generating, by the computing device, modified content based at least in part on the content currently displayed on the electronic paper display; and causing the modified content to be displayed on the electronic paper display.

A fourth further example provides a computing device comprising: a processor; a proximity based wireless device; and a memory arranged to store device-executable instructions that, when executed by the processor, direct the computing system to: read, using the proximity based wireless device, data identifying content currently displayed on a proximate electronic paper display; generate modified content based at least in part on the content currently displayed on the electronic paper display; and cause the modified content to be displayed on the electronic paper display.

A fifth further example provides a display device comprising: an electronic paper display; means for transmitting data identifying content currently displayed on the electronic paper display; means for receiving pixel data for modified content associated with the transmitted data; and means for driving the electronic paper display, wherein the electronic paper display can only be updated to display the modified content when receiving power via the digital data and power bus.

A sixth further example provides a computing device comprising: means for reading data identifying content currently displayed on an electronic paper display; means for generating modified content associated with the received data; and means for causing the modified content to be displayed on the electronic paper display.

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc. and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

The term ‘subset’ is used herein to refer to a proper subset such that a subset of a set does not comprise all the elements of the set (i.e. at least one of the elements of the set is missing from the subset).

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A display device comprising:
an electronic paper display;
a transmitter configured to transmit data identifying content currently displayed on the electronic paper display;
a digital data and power bus arranged to receive pixel data for modified content associated with the transmitted data; and
a processor configured to drive the electronic paper display, wherein the electronic paper display can only be updated to display the modified content when receiving power via the digital data and power bus.

2. A computing device comprising:
a receiver configured to read data identifying content currently displayed on an electronic paper display; and
a processor configured to generate modified content associated with the received data and cause the modified content to be displayed on the electronic paper display.

3. The computing device according to claim 2, wherein causing the modified content to be displayed on the electronic paper display comprises:
providing the modified content to the electronic paper display via an electrical contact-based interface.

4. The computing device according to claim 2, wherein the processor is further configured to
send a request to a content service for the content currently displayed on the electronic paper display, the request comprising the data read by the receiver.

5. The computing device according to claim 2, wherein the processor is further configured to access the content currently displayed on the electronic paper display from a content store using the data read by the receiver.

6. The computing device according to claim 2, wherein the processor is further configured to trigger an action on the computing device or a proximate device based at least in part on the data read by the receiver.

7. The computing device according to claim 6, wherein the action comprises playing or downloading an audio or video file.

8. The computing device according to claim 2, wherein the processor is configured to generate the modified content based at least in part on the received data and according to a pre-defined sequence.

9. The computing device according to claim 8, wherein the processor is configured to generate the modified content by replacing the content currently displayed with a next content element in a pre-defined sequence of content elements.

10. The computing device according to claim 9, wherein no content is visible in a final content element in the pre-defined sequence of content elements.

11. The computing device according to claim 2, wherein the processor is configured to generate the modified content by modifying the content currently displayed in a pre-defined way.

12. The computing device according to claim 11, wherein the processor is configured to generate the modified content by adding an additional element to the content currently displayed.

13. The computing device according to claim 12, wherein the additional element comprises a parameter associated with the computing device.

14. The computing device according to claim 13, wherein the parameter associated with the computing device comprises one of a user name, a device identifier, a date, a time, a mode of operation and a location of the computing device.

15. The computing device according to claim 2, wherein the processor is configured to generate the modified content based at least in part on the content currently displayed on the electronic paper display and a user input received at the computing device.

16. The computing device according to claim 15, wherein the processor is configured to:
display the content currently displayed on the electronic paper display in a graphical user interface on the computing device;
receive user input via a user input device; and
generate modified content by combining the content currently displayed on the electronic paper display and the user input.

17. The computing device according to claim 2, wherein the receiver is a proximity based wireless device and is configured to read the data identifying content currently displayed on the electronic paper display from a proximity based wireless device in a display device comprising the electronic paper display.

18. The computing device according to claim 17, wherein the display device further comprises a contact based conductive digital data and power bus and a processing element configured to drive the electronic paper display, wherein the electronic paper display can only be updated when receiving power via the bus.

19. The computing device according to claim 18, wherein the processor is configured to transmit the modified content to a printer device, the printer device comprising:
a power management device configured to supply at least one voltage for driving the electronic paper display to the contact based conductive digital data and power bus in the display device via one or more contacts on an exterior of the printer device; and
a processing element configured to supply pixel data for the electronic paper display, including pixel data for the modified content, to the contact based conductive digital data and power bus via two or more contacts on the exterior of the printer device.

20. A computer implemented method of updating content displayed on an electronic paper display, the method comprising:
reading, by a receiver in a computing device, data identifying content currently displayed on the electronic paper display;
generating, by the computing device, modified content based at least in part on the content currently displayed on the electronic paper display; and
causing the modified content to be displayed on the electronic paper display.
